(19) United States
(12) Patent Application Publication
(10) Pub. No.: US 2003/0161509 A1
(43) Pub. Date: Aug. 28, 2003

(54) Card one

(76) Inventor: Wesley Eugene Kendall, Altamonte Springs, FL (US)

Correspondence Address: Wesley Eugene Kendall, 106 Pine Needle Lane, Altamonte Springs, FL, 32714, US

(21) Appl. No.: 10/081,036

(22) Filed: Feb. 22, 2002

(51) Int. Cl. G06K 9/00

(52) U.S. Cl. 382/124

(57) ABSTRACT

The systems and process of identification and information through one fixed application or series of applications tied to an identification card. Encoded with all pertinent information including fingerprint and biometric information data. A photo identity would be read at check points throughout terminals of transit and checkpoints, such as borders, airport federal screening points, ports of entry and exit. Cards are read and verified and validated via databases and biometric technology, matching cardholder with card. The card encompasses ticketing, reservations, bag claim, frequent flight account and credit applications: doubles as boarding pass and bag claim. Security checkpoints verify and validate card via federal-local database

### BACKGROUND

This invention pertains to the processing of passengers in mass commercial travel. Its goal is security enhancement fraud and terrorist elimination and identification of all travelers. The related art is photo identification cards, computer card readers, computer data bases, reservation computer systems, baggage identification, frequent flight bonus programs, credit applications and biometric technologies also bar code readers, scanners and computer screen, touch screens.

### SUMMARY

The creation of Cardone pulls all pertinent information into one simple application, system and card; maximizing security and eliminating transaction time. Also, used for visas, passports and staff identity; it is used amongst multiple databases (company, local, state federal) to share verification tasks.

CROSS REFERENCE

USPA 20010034716
USPA 20010024157

1. Process of identification for transit systems/areas

2. The collection of information placed on one card utilized for identification

3. The use of biometrics, digitally captured fingerprint technology placed onto a card linked to a database for identity and clearance and verification/validation

4. Links to reservations, ticketing, federal security, boarding, member profiles, baggage claim and credit applications/databases/transit

5. All encompassing transactions, relations between the federal government, the identification, the cardholder and relating industries.
